(19) United States
(12) Patent Application Publication
(10) Pub. No.: US 2014/0215327 A1
(43) Pub. Date: Jul. 31, 2014

(54) TEXT INPUT PREDICTION SYSTEM AND METHOD

(71) Applicant: Syntellia, Inc., San Francisco, CA (US)

(72) Inventors: Kosta Eleftheriou, San Francisco, CA (US); Ioannis Verdelis, San Francisco, CA (US)

(73) Assignee: Syntellia, Inc., San Francisco, CA (US)

(21) Appl. No.: 14/154,436

(22) Filed: Jan. 14, 2014

Related U.S. Application Data
(60) Provisional application No. 61/758,744, filed on Jan. 30, 2013.
(60) Provisional application No. 61/804,124, filed on Mar. 21, 2013.

(51) Int. Cl. G06F 17/24

(52) U.S. Cl. CPC G06F 17/24
USPC 715/271

(57) ABSTRACT

A word prediction system determines probabilities of next words based upon an n-gram analysis of the input words as a user inputs text into a device. The predicted next words can be predicted based upon the last input word(s) and the predicted next words can be displayed on a predicted word portion of the device. Rather than inputting the letters of the next word, a user can easily input a predicted next word that matches the desired next word.

### CROSS REFERENCE TO RELATED APPLICATIONS

This application claims priority to U.S. Provisional Application No. 61/758,744, “Text Input Prediction System And Method” filed Jan. 30, 2013 and U.S. Provisional Application No. 61/804,124, “User Interface For Text Input On Three Dimensional Interface” filed Mar. 21, 2013, the contents of which is hereby incorporated by reference.

### FIELD OF INVENTION

The present invention is directed towards a typing prediction system.

### BRIEF DESCRIPTIONS OF THE DRAWINGS

FIG. 1A illustrates an embodiment of a bi-gram data file;

FIG. 1B illustrates an embodiment of a tri-gram data file;

FIGS. 2-8 illustrate embodiments of n-gram data listings;

FIGS. 9 and 10 illustrate an embodiment of a portable electronic device;

FIG. 11 illustrates a flowchart of an embodiment of bi-gram word prediction processing;

FIG. 12 illustrates an embodiment of an n-gram data file;

FIG. 13 illustrates a flowchart of an embodiment of tri-gram word prediction processing;

FIGS. 14 and 17 illustrate an embodiment of a portable electronic device; and

FIG. 18 illustrates a block diagram of an embodiment of a portable electronic device.

### DETAILED DESCRIPTION

Typing and text input can be very tedious. In order to improve the speed of text input, word prediction systems can be used in electronic devices. These word prediction systems can detect the words into the device and predict a set of possible next words based upon the input text.

A number of techniques exist that use “n-grams” to deduct a set of next word predictions based upon the input text. N-grams are series of tokens or words, together with frequency data. N-grams may constitute a series of words, or other tokens such as punctuation symbols, or special tokens denoting the beginning of a sentence or a paragraph. The frequency stored may reflect the typical frequency in a language, which may be constructed by analyzing existing text bodies. Bi-grams and tri-grams are examples of N-grams. A bi-gram is any two word combination of text such as “The rain”, “How are”, “Three is” etc. A tri-gram is any three word combination of text, for example, “The rain in”, “How are you”, “Three is the”, etc. The purpose of many typing systems is to use n-gram data in order to create predictions on a typing system. See U.S. Patent Publication No. 2012/0239379, “N-Gram-Based Language Prediction” which is hereby incorporated by reference.

These systems can be used in order to assist the user by offering next word predictions. The system can display a set of suggested words based on the words already entered, and the user can select one of these words as the intended next word from this set. The system will then input the selected word. If the predicted word is accurate, such systems have the advantage of the user not having to type each letter of the next word.

Other systems may utilize n-grams in order to better inform a more comprehensive auto-correct system. For instance, an auto-correct system may perform various analysis on button proximity of the input of the user to replace an invalid entry with a valid word in a system dictionary. N-gram data can be used by such a system to provide more accurate corrections by taking into account the words already entered by the user.

A common problem existing in systems using n-gram data is the memory consumption required to make meaningful predictions. For bi-gram data, a system might need to store x² amount of data in the system RAM, where x is the number of words in the dictionary. This bi-gram data may be stored in the form of a [PreviousWord, NextWord, Probability] data structure. In such a data structure, the system will have to store all possible combinations of words in a dictionary, together with probability—a x² total RAM memory requirement. Various techniques can be used to minimize the amount of memory usage for such a predictive system, such as storing only the most common combinations of words, or storing the combinations of words that are most relevant to a more comprehensive auto-correct system.

For tri-gram data, a system may need to store x³ amount of data in the system RAM, where x is the number of words in the dictionary. Thus, these prediction systems can quickly exhaust the available memory the device might have. Whereas various techniques can again reduce the amount of data needed in RAM, most of these techniques will ultimately reduce the efficiency or accuracy of predictions of a system using n-gram data as they often rely on compromising the amount of n-grams the system has at its disposal.

The present invention includes a disclosure of a method by which a specially formatted binary “n-gram data file” can be created to store n-gram data, allowing the inventive system to perform a binary search directly on the file. This inventive process would enable the n-gram prediction system to work with considerably lower memory consumption, by predominately using a data file stored in rather than RAM memory to perform its analysis. The technique may be especially useful on devices, such as smartphones and tablets that utilize flash memory, where the speed of data retrieval is faster than on disks.

The inventive system uses an n-gram data file that comprises “WordID” and “Probability” types of tokens. WordID refers to a specific word in a language dictionary. The inventive system can be used for text in English or any other language. In an embodiment, the WordID token might be the word itself. Alternatively, the WordID token might be a unique numeric token that is assigned to or associated with each word. In this embodiment, a reference table can be created with each of the numeric WordID tokens and the corresponding words. Table 1 below is an example of a numeric WordID table.

TABLE 1

| WordID Tokens | Word |
|---|---|
| 0001 | this |
| 0002 | is |
| 0003 | was |
| 0004 | planet |
| 0005 | myself |

In an embodiment, the WordID tokens can be referenced in two ways: 1) LWID (last word ID) and 2) NWID (next word ID). The LWID and NWID WordID tokens might each refer to specific words. The difference between LWID and NWID is the order of each in the n-gram listings. The inventive system can also assign a probability for each set of LWID and NWID WordID tokens. Probability refers to the likelihood of a specified n-gram which can be a numeric value or numeric probability. The numeric probability value can be stored in the reference table may be the Bayesian probability of this n-gram. Alternatively, the probability can be the number of times this particular n-gram appears in a reference body of text. The inventive system might also store a “less granular” probability number. For example, rather than having a pure numeric probability, the system can split all probabilities into 256 levels of probabilities, or store a logarithm of the number of occurrences of the n-gram. The probability can be a relative factor in that any scale of probability can be used as long as the differences in probability values corresponds to a reasonable likelihood that each NWID will be the next word after an LWID.

Table 2 below is an example of an embodiment of a bi-gram for the WordIDs listed above in Table 1. The numbers under “LWID” and “NWID” are the WordIDs and “P” is the probability.

TABLE 2

| LWID (word) | NWID (word) | P |
|---|---|---|
| 0001 (this) | 0002 (is) | 1000 |
| 0001 (this) | 0003 (was) | 0500 |
| 0001 (this) | 0005 (myself) | 0003 |
| 0002 (is) | 0001 (this) | 0500 |
| 0002 (is) | 0004 (planet) | 0001 |
| 0004 (planet) | 0001 (this) | 0010 |
| 0005 (myself) | 0001 (this) | 0020 |

The P value listed can be any number that corresponds to a relative probability that a NWID will appear after the LWID. In different embodiments, the P value can be a count of times the word is normally used in a document(s), or a log count, or anything that evaluates word use frequency. In this example, the LWID 0001 corresponds to the word “this” and the NWID 0002 corresponds to the word “is” and therefore the bi-gram is “this is.” The probability of the bi-gram “this is” can be based upon the appearance of this bi-gram in a sample text. In this example, the bi-gram can appear 1000 times in the sample text, which is significantly higher than the other bi-grams in Table 2. In this example, the bi-grams “this was” and “is this” can each appear 500 times in the sample text and the bi-gram “is planet” only appears once. If a bi-gram does not exist in the sample text, it may not be listed in the bi-gram probability table or used to predict next word text.

The sample text can be any writing of words that correspond to common writing. For example, a dictionary with an alphabetical listing of all words would not be a good sample text because all words would be present once and the sequence of words would be purely alphabetical. However, any writing with proper grammar and common word usage might be a suitable sample text for determining n-gram probabilities. The user's own writings could be used as the sample text to produce a more personalized n-gram probability table. In other embodiments, the sample text can be combination of writings from a plurality of authors and may include writings from the user.

The probabilities of bi-grams can be empirically estimated based on the occurrences of n-grams in the sample text. In an embodiment, the bi-gram analysis can be performed by a computer that is programmed to review the sample text. The computer can output the number of occurrences of all bi-grams and the number of occurrences of each bi-gram or n-gram can then be used as a measure of probability. In order to obtain an accurate level of n-gram probability, a large volume of common user writing should be analyzed. Although this embodiment of the invention describes bi-gram word prediction, in other embodiments, this probability information can be applied to tri-gram, quadgram, etc. using the described process.

In an embodiment, the system might include WordID tokens for both words and other input information that are not words. For example, the WordID tokens may also be used for other input notations such as punctuations, start of a sentence, end of a sentence, etc. Table 3 below includes the WordIDs from Table 1 and has added WordID tokens for additional input information. In the example, the input information “<S>” means the beginning of a sentence and “</S>” means the end of a sentence.

TABLE 3

| WordID | Word or other input |
|---|---|
| 0001 | this |
| 0002 | is |
| 0003 | was |
| 0004 | planet |
| 0005 | myself |
| 9998 | <S> |
| 9999 | </S> |

Table 4 below illustrates an example of a bi-gram table that includes the sentence position WordIDs. In this example, the first word “This” is more probable because it is commonly used as the first word in a sentence. The word Planet is rarely used as the first word in a sentence but more frequently used sometimes at the end of a sentence. Thus, with this beginning/end of sentence information can be used as a WordID token and the inventive system can be used to predict when words are likely to be used at the beginning or end of a sentence. In other embodiments, the inventive system can predict when a word is likely to be used with punctuation marks and symbols such as: . , ! ? @ # $ % */etc. These sentence positions, punctuation marks and symbols which can each have a WordID token can all be “non-word input features.”

TABLE 4

| LWID | NWID | P |
|---|---|---|
| 9998 (beginning of sentence) | 0001 (this) | 1000 |
| 9998 (beginning of sentence) | 0004 (planet) | 0002 |
| 0004 (planet) | 9999 (end of sentence) | 0050 |

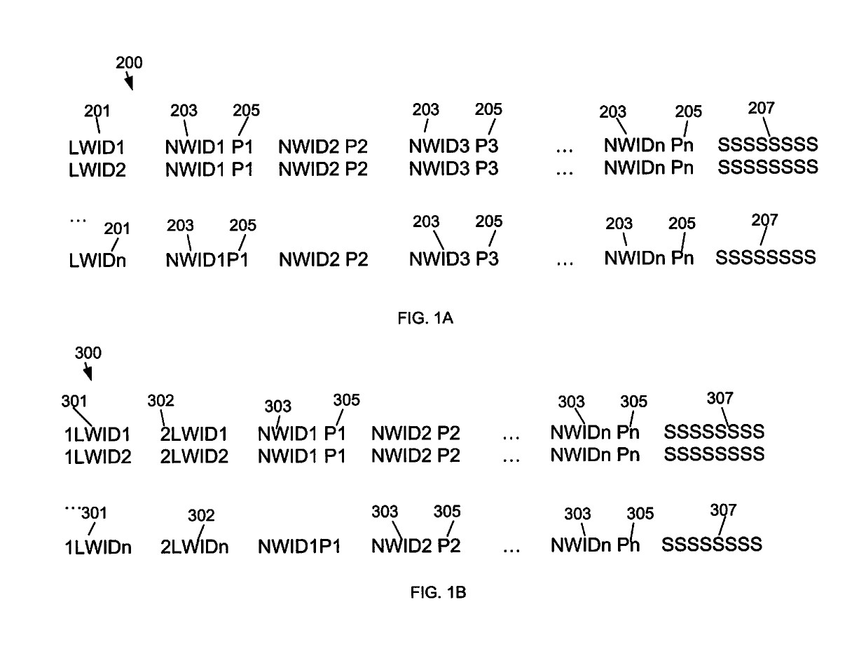

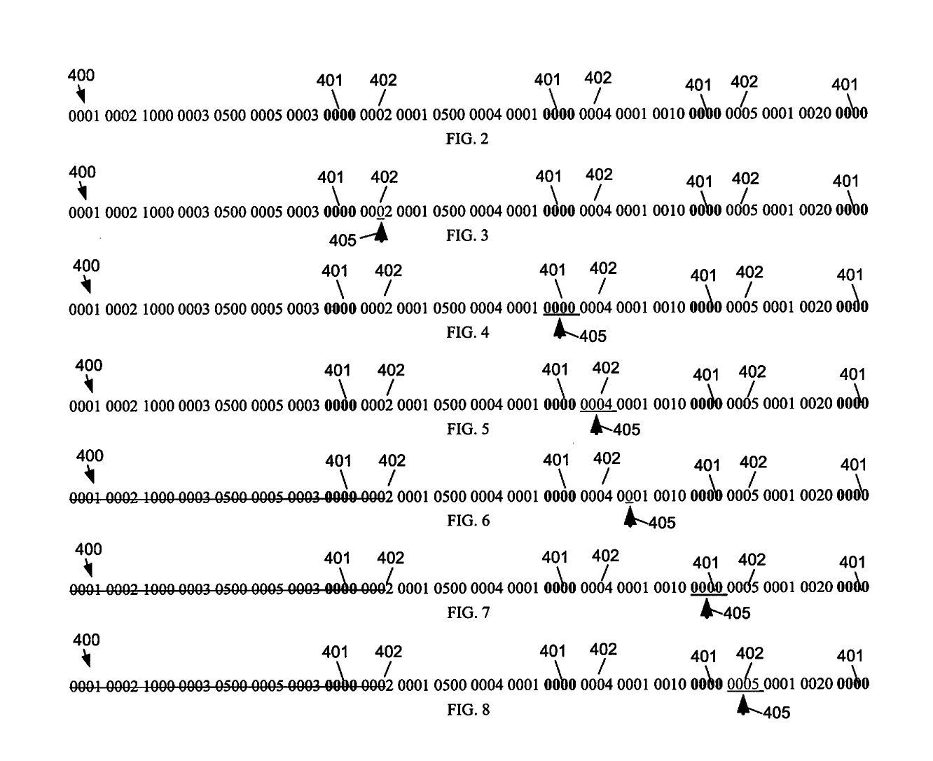

When the inventive system is used to predict the next word in a text input, the system can have a bi-gram data file 200 that is formatted as shown in FIG. 1A. The bi-gram data file 200 can be structured as a sequential plurality of “bi-gram listings.” Each bi-gram listing can include an LWID 201 followed by one or more NWIDs 203. Each NWID 203 can have an associated P value 205 for the combination of the LWID 201 and NWID 203. The number of NWIDs 203 and P values 205 can vary depending upon the commonality of the LWID 201 being combined with other words. In some embodiments, the system may have a predetermined limitation on the number of NWIDs 201 that can be associated with a single LWID 201 in a bi-gram listing. For example, the inventive system may limit the number of NWIDs 203 in the bi-gram listing to 50 or any other suitable number. In the bi-gram data file, sentinel values SSSSSSSS 207 can be used to separate each of the bi-gram listings which each include one LWID 201 and all associated NWIDs 203 and probabilities P values 205 for each of the NWIDs 203. Thus, the entire bi-gram data file 200 can be a single string of LWIDs 201, NWIDs 203, P values 205 and sentinel values 207.

In other embodiments, additional LWIDs 201 can be used in each n-gram listing. With reference to FIG. 1B, in an embodiment, if a tri-gram prediction method is being illustrated, each tri-gram listing 300 can include a first NWID 301, “1LWID_” and a second LWID 302, “2LWID_.” Like the bi-gram system described in FIG. 1A, the first LWIDs 301 and the second LWIDs 302 are followed by sets of NWIDs 303 and associated probabilities 305. Again, in the tri-gram data file, sentinel values SSSSSSSS 307 can be used to separate each of the tri-gram listings which each include two LWIDs 301, 302 and all associated NWIDs 303 and probabilities P values 305 for each of the NWIDs 303. Thus, the entire bi-gram data file 200 can be a single string of LWIDs 201, NWIDs 203, P values 205 and sentinel values 207.

Similar n-gram listings can be applied to quad-grams and even higher level n-grams. In the n-gram data file, sentinel value SSSSSSSS 207, 307 can be used to separate each of the n-gram listings which each include one or more LWIDs and all associated NWIDs and probabilities for each of the NWIDs. The entire n-gram data file can be a single string of LWIDs, NWIDs, P values and sentinel values.

Table 5 below illustrates an example of a tri-gram table. As discussed, this table is similar to a bi-gram table such as Tables 2 and 4. However, there is a 1LWID and a 2LWID for each NWID. The probability can be lower because there can be fewer instances of the word sequence 1LWID, 2LWID in the sample text. In this example, the word combination “this is myself” may occur 300 times in the sample text and the word combination “this was planet” may occur 200 times. Thus, the tri-gram table can provide a relative probability of the three word combinations.

TABLE 5

| 1LWID (word) | 2LWID (word) | NWID (word) | P |
|---|---|---|---|
| 0001 (this) | 0002 (is) | 0005 (myself) | 0300 |
| 0001 (this) | 0003 (was) | 0004 (planet) | 0200 |
| 0001 (this) | 0004 (planet) | 0003 (was) | 0500 |
| 0002 (is) | 0001 (this) | 0004 (planet) | 0100 |
| 0002 (is) | 0001 (this) | 0005 (myself) | 0005 |
| 0004 (planet) | 0002 (is) | 0001 (this) | 0010 |
| 0005 (myself) | 0003 (was) | 0001 (this) | 0001 |

LWIDs should be stored in the n-gram data file in a predetermined sorted manner. In different embodiments, the LWIDs can be stored in various sequential orders that can be ascending or descending. The order of LWIDs in the n-gram data file can be organized in order based upon: alphabetical, frequency of use, etc. For example, the n-gram data file can be organized like a dictionary in a descending order based upon the LWID of each of the n-gram listings. In other embodiments, the n-gram data file can be organized based upon the popularity of the word in text so that common words such as: the, a, etc. can be towards the front of the n-gram data file and less common words can be towards the end of the file.

Like the LWID, the NWID can be a numeric WordID token for a specific word and the P can be the numeric probability of that NWID following the LWID in the intended next word. The numeric values of the LWIDs and NWIDs can be obtained from the same reference file which stores unique numeric WordID token for each word. Thus, if a numeric WordID token for an LWID is the same as a numeric NWID WordID token for a NWID, both of these tokens refer to the same word.

In this example, the “SSSSSSSS” can be a “sentinel value” and in the number following the sentinel value is the LWID. One or more NWIDs can follow each LWID. The NWIDs can be stored in a sorted manner so that NWID1 has higher probability than NWID2 which can have a higher probability than NWID3, etc. This allows the system to easily display the predicted words associated with the highest probabilities first and then display the lower probability words later if necessary. However, sorting the NWIDs in a descending probability organization is not required. In an embodiment, the system can review the probabilities of each NWID in the n-gram data listing and display the NWID words in the order of highest probability.

In an implementation of the inventive system, the following memory requirements can be associated with each piece of data stored in the tables and/or n-gram data listing. Each of the WordIDs can require 2 bytes of memory and the first ID can be 1 byte. The probabilities “P” can be 1 byte each. If the probability is zero the corresponding WordID may not be stored in the tables or n-gram data listing. The sentinel value can be 2 bytes and might have a null value, 0, 0. In this configuration, when the n-gram data listing is being searched and 2 bytes of zeros are found in the file, the system will know its pointer is at a sentinel delimiter.

An example use of the inventive system can start with a user typing the word, “Is”. We know this is WordID=0002 from Table 1. The system will then find the likely next words after this token, with their probability. The system can open the n-gram data file and place a pointer in the middle of the file. The system can then read the data at this center point. Since the n-gram data file is a series of bytes in a binary file, the system does not know what it is reading at this point. If the first point is not a sentinel value, the system can move the pointer forward until it encounters the sentinel value. In this embodiment, the sentinel value can always be recognized, since only sentinel values are 2 consecutive bytes containing zeros.

The system then moves the pointer immediately after this sentinel value to identify the LWID. The n-gram data listing is configured so that an LWID always follows the sentinel. In FIG. 1A, the sentinel value 207 is on the right column and the next LWID 201 is in the left column on the next row. The system also knows how long an LWID 201 is. In this example, LWIDs 201 are all 2 bytes. The system can read the LWID 201 and if the LWID is not 2 bytes, the system will know that there was an error in the n-gram data listing. As in a standard binary search, the system knows that the LWID 201 it is looking for is either (0002) or not (0002). If the system reads an LWID 201 number that is higher than (0002), the system knows to look at the first half of the n-gram data file organized in an ascending order in the same way. The system will go to the middle of the first half, and repeat the described process recursively until the system finds the (0002) LWID 201 that it is looking for. If the file is sorted in a descending order, the system will look at the second half of the file 200 and repeat the described process recursively until the system finds the LWID 201 that it is looking for.

This method enables the system to perform a fast binary search directly on the file, until it has found where the LWID searched for is located. In this example, the binary search enables the system to find the location of an LWID for “is” in the file. The bi-grams cover the phrases “Is this”, “Is that”, etc. Once the system has found the LWID it was looking for, the system reads all the NWID and P data that follows the LWID, until the system re-encounters the sentinel value. This will provide the system all the NWID and P pairs for this LWID. These NWID and P pairs can be stored in memory by the system. The only memory that the system needs to keep in RAM is the bi-grams specific to the relevant “previous word” LWID that the user just typed. Thus, the inventive system does not need to store every possible combination of words in a language in RAM. It instead uses the data file and performs a binary search directly on the file.

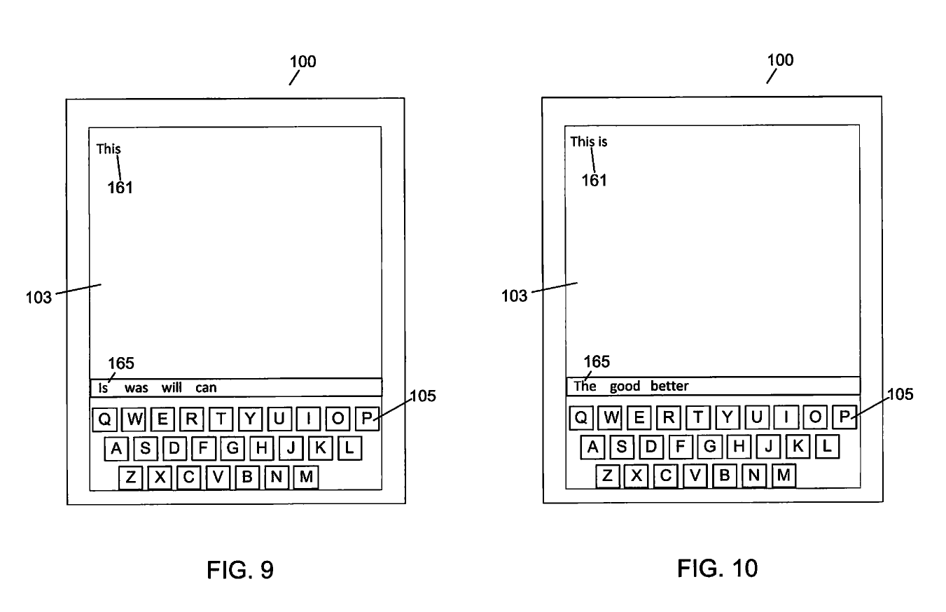

FIGS. 2-8 illustrate an example n-gram data listing based upon Table 2 above. As discussed, the sentinel values 0000 401 each indicate that the following number is a new LWID 402. Rather than repeating the LWID 402, each LWID 402 is only listed once immediately after the sentinel value 0000 401. With reference to FIG. 2, a listing 400 is shown and the LWIDs 402 are 0002, 0004 and 0005. In this example, the user has typed “myself” into an input device. The system looks up the word “myself” on the wordID Table 1 and determines that “planet” is LWID=0005. The inventive system wants to know probabilities for words after “myself”, and start the binary search of the n-gram data file. With reference to FIG. 3, a pointer 405 can be thrown in the middle of the n-gram data file 400, to provide a starting point for the search to begin. This point is designated in this example as the underlined and pointer indicated number 0002. With reference to FIG. 4, from the starting point, the system moves the pointer 405 forward to the right until the pointer 405 encounters the next sentinel value, 0000 401. With reference to FIG. 5, the WordID following the sentinel value 401 is 0004. Since the WordID 0004 does not match 0005, the system repeats the described search process. Since 0005 is larger than 0004, the system places the next search pointer 405 to the right of the last WordID 0004 as shown in FIG. 6. The smaller WordIDs to the left of where we originally threw this pointer 405 is not useful for this search and have been striked through to show that these WordIDs are no longer part of the search. The system moves the pointer 405 to the middle of the second half of the n-gram data listing. The system then moves the pointer 405 to the right to the next sentinel value 401, as shown in FIG. 7. The WordID to the right of the sentinel value 401 is 0005 which matches the 0005 search term as shown in FIG. 8.

After the matching WordID is found, the system then reads the LWID following the WordID 0005. In this example, the LWID is “0001” which corresponds to “this” in Table 1 and the probability is 0020, which means “this” has a relative probability of 0020 of being the next word after myself. In this example, “this” is the only WordID before reencountered the sentinel. The inventive system can display the predicted words on the display for the user. If the predicted words match the intended word of the user, the user can select the predicted word and the system can add this to the text being input by the user. If the user's intended word does not match any of the predicted words, the user can type in the next intended word and the process can be repeated. In the listing shown in FIGS. 2-7, the WordIDs after 0001 are: 0002, 0003 and 0005 which correspond to the words: is, was and myself. The corresponding probabilities are 1000, 0500 and 0003 respectively. If the system did not find the LWID it was searching for, the system can again divide the appropriate half of the n-gram data file and repeat the process until the search WordID is found.

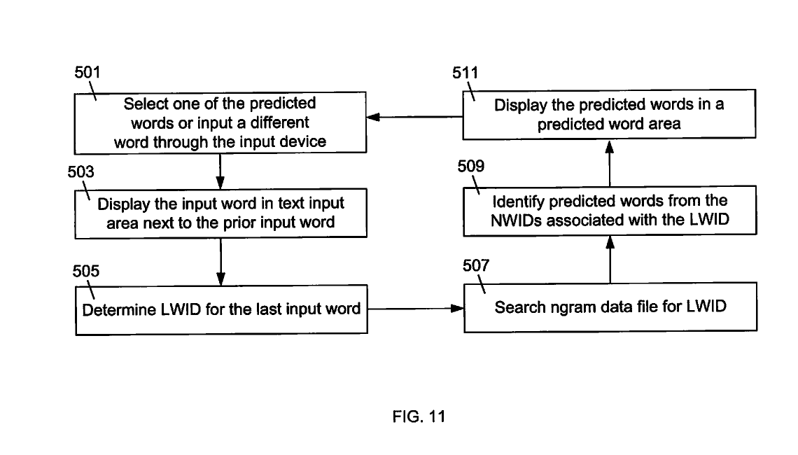

With reference to FIGS. 9 and 10, the described process can be illustrated from the user's perspective on a portable electronic device 100 having a display 103 and a keyboard 105. In FIG. 9 the user has typed in the word, “This” 161. The system can respond by displaying the words “is was will can” in the predicted word area 165. The word “is” may be the intended word of the user. The user can choose the word “is” in the predicted word area 165 which causes the system to display the sequence of words “This is” as shown in FIG. 10. The system can then repeat the process and display a new set of predicted words, “the good better” in the predicted word area 165. The system can display the words in the predicted word area 165 in a sequence based upon the probability of each word.

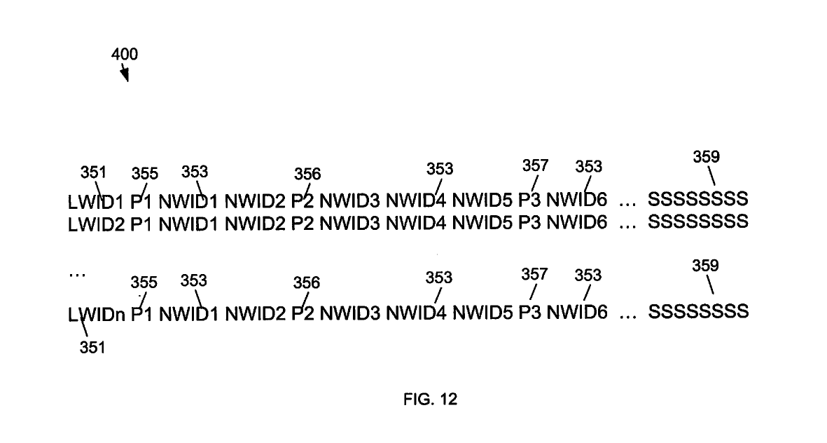

With reference to FIG. 11 a basic flowchart of the application of the inventive bi-gram word prediction method is illustrated. As the user types words into the device, the system can display sets of suggested words based upon the prior input word. The user can select one of the predicted words or input a different word through the input device 501, which can be a keyboard, a touch screen virtual keyboard, a three dimensional space keyboard or any other suitable input device. An example of a three dimensional space interface is disclosed in U.S. patent application Ser. No. 61/804,124, “User Interface For Text Input On Three Dimensional Interface” filed on Mar. 21, 2013, which is hereby incorporated by reference in its entirety. The system can then display the selected or input word next to the prior input word 503. The system can then determine the LWID token for the newly input word 505. The LWID token can be used to search the n-gram data file 507 as described above. Once the LWID token is found in the n-gram data file, the associated NWIDs can be identified 509. The predicted words for the associated NWIDs can be displayed in a predicted word area of the device 511. The predicted words can be displayed in an order based upon the associated bi-gram probability. If the intended next word is not displayed, the user can input a command for additional predicted words which will replace the first set of predicted words in the predicted word area. The described process can then be repeated.

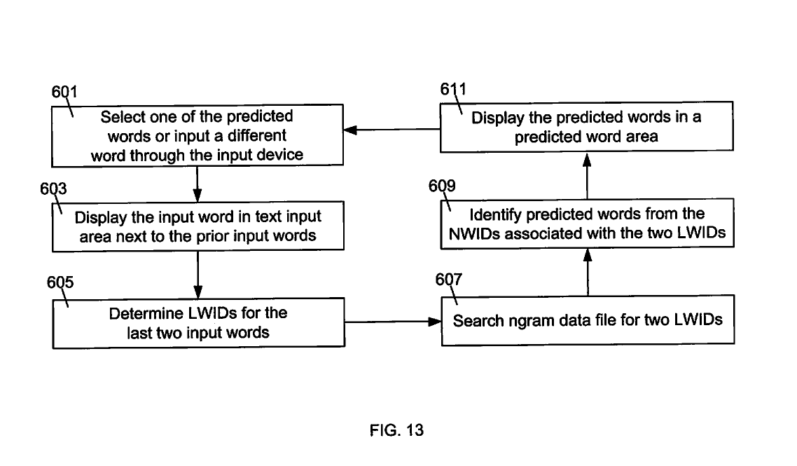

In other embodiments, many different file formats can be used, as long as the sentinel value may not appear in a sequence of the listing anywhere else in the file and the file is structured with the LWIDs in a sorted manner. For example, with reference to FIG. 12, an alternate embodiment of the listing is illustrated. This embodiment keeps the LWIDs 351 in order, but instead of then storing the NWIPs 353 and corresponding probabilities as individual data pairs, the n-gram data listing 350 can store one probability 355 for a plurality of NWIDs 353. This may require less device storage and may be useful if more than one NWID 353 has the same probability or a similar probability after the LWID 351. This might be common if the system stores “probability” as a rank or non-granular number so many next words fall into the same or similar numeric probability. The system might provide a standardized number of words under each probability 355, 356, 357, or to control the file so a specific number of words follow each probability 355, 356, 357. In this example, the first LWID 351 is followed by a first probability 355 and NWID1 353 and NWID2 353. The next probability P1 356 is followed by NWID3 353, NWID4 353 and NWID5 353. The following probability P3 357 is followed by NWID6 353 . . . This data configuration can be interpreted as probability P1 355 applying to NWID1 353 and NWID2 353, probability P2 356 applying to NWID3 353, NWID4 353 and NWID5 353 and probability P3 357 applying to NWID6 353. Each LWID 351 can be listed once immediately after the sentinel values SSSSSSSSS 359.

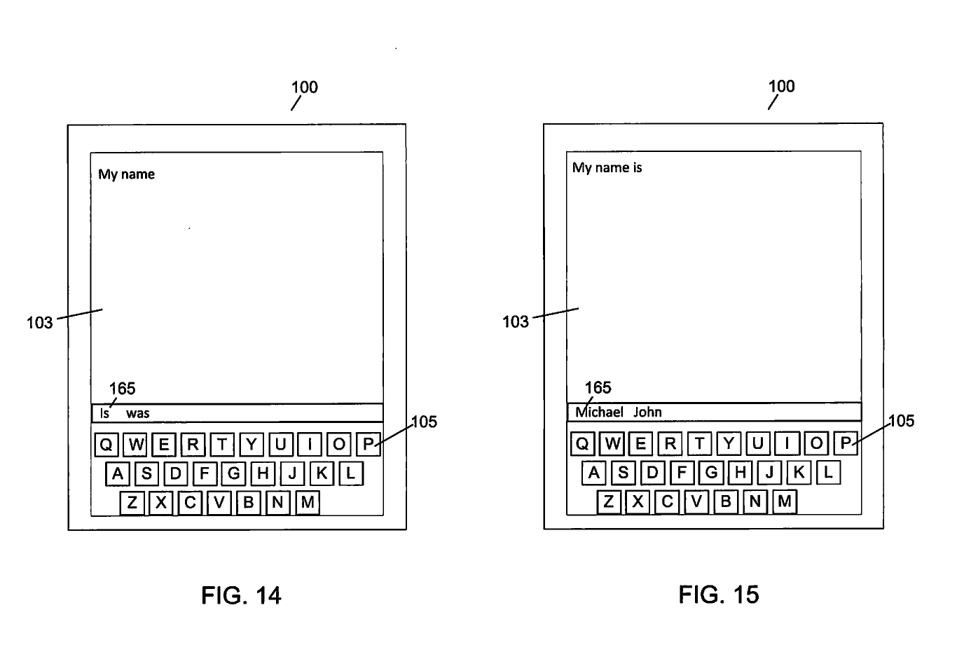

With reference to FIG. 13, a flowchart of the application of the inventive tri-gram word prediction method is illustrated. The process is similar to the flowchart described above with reference to FIG. 11. During text input, the user either selects a predicted word or inputs a word through the input device 601. The selected or input word is displayed next to the prior input words 603. The system determines the LWIDs for the last two input words 605. The system then searches the n-gram data file for the n-gram listing associated with the last two input words 607. The system then identifies the predicted words from the NWIDs associated with the searched two LWIDs 609. The system displays the predicted words on the device in the predicted word area 611. The user can scroll through additional predicted words if necessary. The user can then select or input the next word and the described process can be repeated.

This same process can be applied to other searches. The above examples show bi-gram word predictions. However, in other embodiments, the inventive system could do the same for tri-gram word predictions. As an example, the listing might include “0000 My name Is 1000 . . . ” In this example, the listing can include words WordID tokens rather than numeric WordID tokens. The LWID following the sentinel value in this example can be “My name” token and the first predicted NWID can be “is” token with a numeric probability of 1000. The user can select the predicted word “is” so the displayed text becomes “My name is” and the system can predict a next set of predicted words based upon the described tri-gram word prediction method.

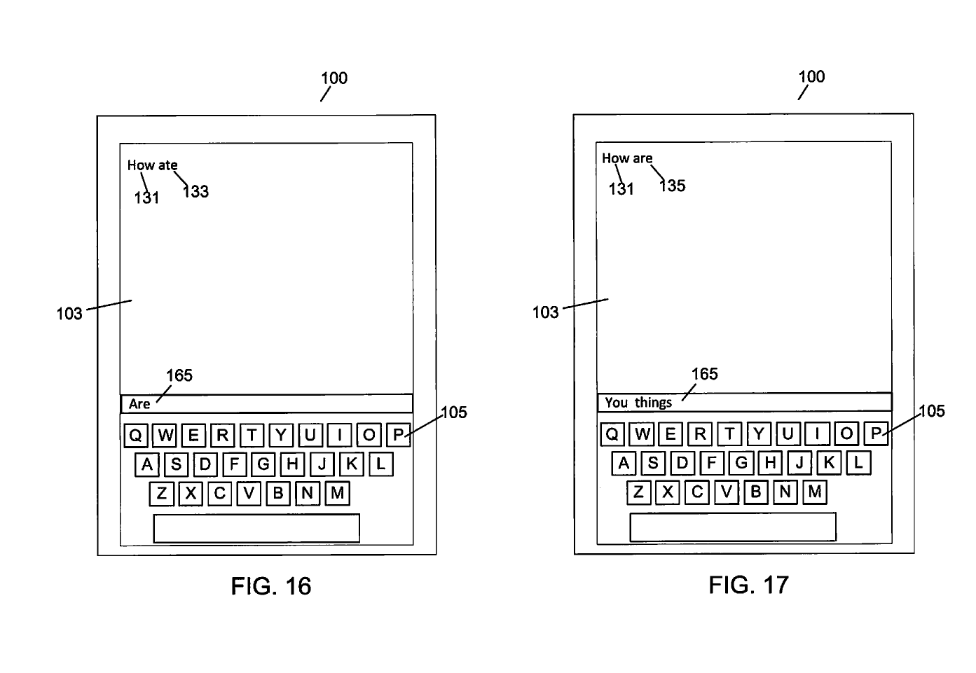

With reference to FIGS. 14-15, a top view of an exemplary electronic device 100 is illustrated that implements a touch screen display/input 103, a touch screen-based virtual keyboard 105 and a predicted word area 165. Applying this example to a device 100, the first two input words in the display/input 103 are “My name”. The system can identify the NWIDs that can correspond to the words “is” and “was”, which are displayed in the word prediction area 165. In FIG. 15, the user has selected the word “is” and the text in the display/input 103 is now “My name is”. The system then identify the new NWIDs for “name is” as “Michael” and “John” which are then displayed in the word prediction area 165.

In an embodiment, the inventive system can have “threaded operation” that can be run in a separate thread from other components of an auto-correct system. In an implementation, the system can perform the described lookup for “next word predictions” while the user is actually typing this next word. For example, with reference to FIGS. 16 and 17, a user can type “How” 131 and then input a space as shown in the display/input 103. The inventive system can respond to the space input by searching for next word predictions in the background while the user types “are”. By the time the user inputs the space, the inventive system knows all the probabilities of words that might by typed after “How” 131. This feature can also be incorporated into an auto-correct system. If a user typed an LWID “How” 131 followed by the word “ate” 133 (normally a valid word), the system would know that the combination, “How ate” is highly unlikely and could attempt to correct the text by changing the word “ate” 133 to “are” 135. In some embodiments, the inventive system can make this correction automatically because the numeric prediction values for “ate” 133 after “How” 131 can be very low or zero.

In the invention implementations described above, the system can perform a simple binary search on the n-gram data file. In other embodiments, the system might improve the algorithm's performance by keeping some pointers to reference LWIDs so we initially place the pointer in a more relevant place on the file. For example a pointer may kept to intervals of LWID=[1, 500, 1000, 1500 . . . ] so that the initial placement of the pointer in the search is closer to the lookup value.

In other embodiments, the system might perform different binary searches of the listing. In the examples described above, the system can perform a standard binary search where the pointer divides the remainder of the listing in half each time the search WordID is not found. In other embodiments, other types of binary searches can be performed. For example, by moving the pointer to a different portion of the listing each time. For example, the system might move the pointer closer to either end of the listing area being searched based upon the difference between the found WordID and the search WordID. For example, if the search WordID is 0005 and the found WordID is 0004, the system can know that the search WordID is very close to the found WordID and move the search pointer a shorter distance to the right of the found WordID. In contrast, if the found WordID is 0001 and the Search WordID is 0005, the system can know to move the pointer a farther distance from the found WordID 0001.

The inventive prediction and correction system could also be run on a separate server that is in communication with the input device. The input device could send the last input word to a server, and then while the user types the next word, the server could be calculating the predicted next words and the probabilities for each of the predicted next words. These predicted next words can be transmitted to the user's device.

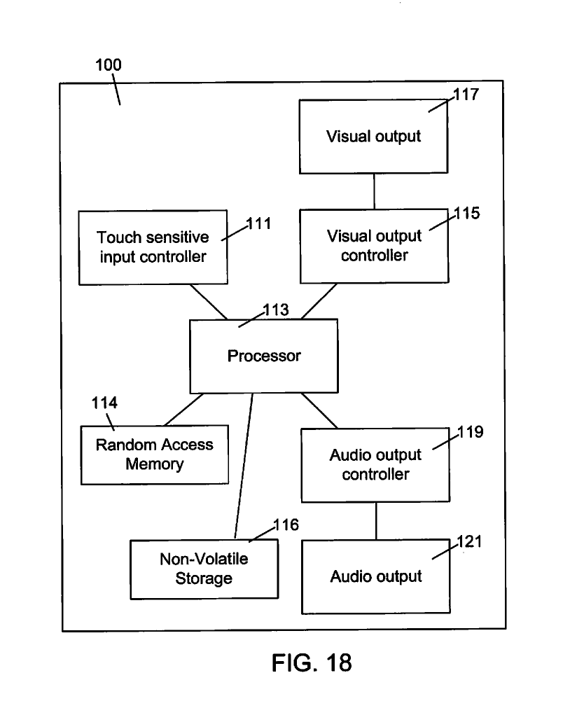

With reference to FIG. 18, illustrates a block diagram of an embodiment of the device capable of implementing the current invention. The device 100 may comprise: a touch-sensitive input controller 111, a processor 113, a database 114, a visual output controller 115, a visual display 117, an audio output controller 119, and an audio output 121. The top view of the device 100 illustrated in FIGS. 14-17 includes an input/display 103 that also incorporates a touch screen. The input/display 103 can be configured to display a graphical user interface (GUI). The GUI may include graphical and textual elements representing the information and actions available to the user. For example, the touch screen input/display 103 may allow a user to move an input pointer or make selections on the GUI by simply pointing at the GUI on the input/display 103.

The GUI can be adapted to display a program application that requires text input. For example, a chat or messaging application can be displayed on the input/display 103 through the GUI. For such an application, the input/display 103 can be used to display information for the user, for example, the messages the user is sending, and the messages he or she is receiving from the person in communication with the user. The input/display 103 can also be used to show the text that the user is currently inputting in text field. The input/display 103 can also include a virtual “send” button, activation of which causes the messages entered in text field to be sent.

The input/display 103 can be used to present to the user a virtual keyboard 105 that can be used to enter the text that appears on the input/display 103 and is ultimately sent to the person the user is communicating with. The virtual keyboard 105 may or may not be displayed on the input/display 103. In an embodiment, the system may use a text input system that does not require a virtual keyboard 105 to be displayed. For example, the inventive system can be used in embodiments that do not require a virtual keyboard 105 such as any non-keyboard text input embodiments or an audio text input embodiment.

If a virtual keyboard 105 is displayed, touching the touch screen input/display 103 at a “virtual key” can cause the corresponding text character to be generated in a text field of the input/display 103. The user can interact with the touch screen using a variety of touch objects, including, for example, a finger, stylus, pen, pencil, etc. Additionally, in some embodiments, multiple touch objects can be used simultaneously.

Because of space limitations, the virtual keys may be substantially smaller than keys on a conventional computer keyboard. To assist the user, the system may emit feedback signals that can indicate to the user what key is being pressed. For example, the system may emit an audio signal for each letter that is input. Additionally, not all characters found on a conventional keyboard may be present or displayed on the virtual keyboard. Such special characters can be input by invoking an alternative virtual keyboard. In an embodiment, the system may have multiple virtual keyboards that a user can switch between based upon touch screen inputs. For example, a virtual key on the touch screen can be used to invoke an alternative keyboard including numbers and punctuation characters not present on the main virtual keyboard. Additional virtual keys for various functions may be provided. For example, a virtual shift key, a virtual space bar, a virtual carriage return or enter key, and a virtual backspace key are provided in embodiments of the disclosed virtual keyboard.

It will be understood that the inventive system has been described with reference to particular embodiments, however additions, deletions and changes could be made to these embodiments without departing from the scope of the inventive system. Although the order filling apparatus and method have been described include various components, it is well understood that these components and the described configuration can be modified and rearranged in various other configurations.

What is claimed is:

1. A method for predicting a text input by a user comprising the steps:
providing a device having: an input device, a processor, a memory and an output device;
storing in the device, a plurality of WordID tokens and corresponding words, each of the plurality of WordID tokens corresponding to a different word or a non-word input feature;
storing in the device, a plurality of bi-gram listings, each of the bi-gram listings includes a Last Word ID, one or more Next WordIDs and probability values for each of the sequential combinations of the Last WordID with the one or more Next WordIDs;
providing in the device, an n-gram data file that includes the plurality of bi-gram listings and sentinel values, each of the sentinel values is between each of the plurality of bi-gram listings;
identifying a first Last WordID token associated with a first word input to device;
searching the bi-gram data file for the first Last WordID token;
determining the one or more Next WordIDs associated with the first Last WordID token; and
outputting predicted words that is associated with each of the one or more Next WordIDs through the output device.

2. The method of claim 1 wherein the output device is a visual display.

3. The method of claim 2 further comprising:
displaying the first word in a text input area of the visual display; and
displaying the predicted words in a predicted word area of the visual display.

4. The method of claim 3 further comprising:
selecting one of the predicted words;
inputting into the device the predicted word that was selected; and
displaying the predicted word that was selected next to the first word in a text input area of the visual display.

5. The method of claim 1 wherein the device includes an auto-correction system that utilizes the predicted words from the bi-gram data listing.

6. The method of claim 1 wherein the bi-gram data file is a single binary data file.

7. The method of claim 1 wherein the memory of the device includes random access memory and non-volatile memory and the bi-gram data file is stored in the non-volatile memory.

8. The method of claim 1 wherein the memory of the device includes random access memory and non-volatile memory and the bi-gram data file is not stored in the random access memory.

9. The method of claim 1 further comprising:
formatting the bi-gram data file for binary searches; and
searching the bi-gram data file for Last WordIDs.

10. The method of claim 1 wherein the bi-gram listings are separated by sentinel values in the bi-gram data file.

11. A method for predicting a text input by a user comprising the steps:
providing a device having an input device, a processor, a memory and an output device;
storing in the device, a plurality of WordID tokens and corresponding words, each of the plurality of WordID tokens corresponding to a different word or a non-word input feature;
storing in the device, a plurality of tri-gram listings, each of the tri-gram listings includes a first Last WordID, a second Last WordID, one or more Next WordIDs and probability values for each of the sequential combinations of the first Last WordID, the second Last WordID with the one or more Next WordIDs;
providing in the device, a tri-gram data file that includes the plurality of tri-gram listings and sentinel values, one of the sentinel values is between each pair of the plurality of tri-gram listings;
identifying a first Last WordID token associated with a first word and a second Last WordID token associated with a second word input to device;
searching the tri-gram data file for the first Last WordID token and the second Last WordID token;
determining the one or more Next Word IDs associated with the first Last WordID token and the second Last WordID token; and
outputting predicted words that is associated with each of the one or more Next WordIDs through the output device.

12. The method of claim 11 wherein the output device is a visual display.

13. The method of claim 12 further comprising:
displaying the first word and the second word in a text input area of the visual display; and
displaying the predicted words in a predicted word area of the visual display.

14. The method of claim 13 further comprising:
selecting one of the predicted words;
inputting into the device the predicted word that was selected; and
displaying the predicted word that was selected next to the second word in a text input area of the visual display.

15. The method of claim 11 wherein the device includes an auto-correction system that utilizes the predicted words from the tri-gram data listing.

16. The method of claim 11 wherein the tri-gram data file is a single binary data file.

17. The method of claim 11 wherein the memory of the device includes random access memory and non-volatile memory and the tri-gram data file is stored in the non-volatile memory.

18. The method of claim 11 wherein the memory of the device includes random access memory and non-volatile memory and the tri-gram data file is not stored in the random access memory.

19. The method of claim 11 further comprising:
formatting the tri-gram data file for binary searches; and
searching the tri-gram data file for Last WordIDs.

20. The method of claim 11 wherein the tri-gram listings are separated by sentinel values in the tri-gram data file.
